(19) United States
(12) Patent Application Publication
(10) Pub. No.: US 2009/0076850 A1
(43) Pub. Date: Mar. 19, 2009

(54) System for electronic prescriptions

(76) Inventors: Douglas M. Hansell, Newton, MA (US); Francis Grosso, Boston, MA (US)

Correspondence Address: MCDERMOTT WILL & EMERY LLP, 600 13TH STREET, N.W., WASHINGTON, DC, 20005-3096, US

(21) Appl. No.: 12/076,236

(22) Filed: Mar. 14, 2008

Related U.S. Application Data
(60) Provisional application No. 60/906,806, filed on Mar. 14, 2007.

(51) Int. Cl. G06Q 50/00

(52) U.S. Cl. 705/3; 705/2

(57) ABSTRACT

A system and method are provided for electronic prescriptions. When a pharmacist receives a prescription that is denied by a patient's insurance company, the pharmacist enters information about the refused prescription into an electronic processing module. The information is submitted to an electronic processing tool which searches for alternative drugs and submits a report to the prescribing physician regarding the prescription's refusal and requesting correction. Upon receipt of the corrected prescription, the prescription is transmitted back to the pharmacist.

### RELATED APPLICATIONS

This application claims priority from Provisional U.S. patent application Ser. No. 60/906,806 entitled “System for Electronic Prescriptions”, which was filed on Mar. 14, 2007, the contents of which is incorporated herein by reference in its entirety. This application is related to U.S. patent application Ser. No. 10/262,773, the contents of which is incorporated herein by reference in its entirety.

### FIELD OF THE INVENTION

The present disclosure related generally to preparing pharmaceutical prescriptions, and more particularly to electronic pharmaceutical prescriptions.

### BACKGROUND

Typically, when prescribing a drug to a patient, the physician writes the prescription and provides it directly to the patient. The patient then takes the written prescription to a pharmacy to have the prescription filled by the pharmacist. The pharmacist must then read the prescription and attempt to fill it. Any errors in the prescription are left to the pharmacist for correction. Correction typically involves calling the physician and/or the insurance company to resolve the problems. This is time consuming for the pharmacist, and also interrupts the prescribing physician's workflow.

It would be desirable to have an electronic communication system whereby the pharmacy and the prescribing physician can resolve problems electronically.

### SUMMARY

Accordingly, a system and method are provided for electronic prescription processing. The system includes a communications module for receiving, from a pharmacy or other dispensing location, a notification that a prescription cannot be filled and a prescription error processing module for generating an electronic report to the prescriber, the report informing the prescriber of one or more problems associated with the prescription and requesting correction, and a method for communicating the corrected prescription from the physician back to the pharmacist or nurse.

### BRIEF DESCRIPTION OF THE DRAWINGS

FIG. 1 depicts a block diagram for implementing an electronic prescription system.

FIG. 2 depicts a user interface for generating a notification of a defective prescription.

FIG. 3 depicts an overall method for electronic prescription processing.

### DETAILED DESCRIPTION

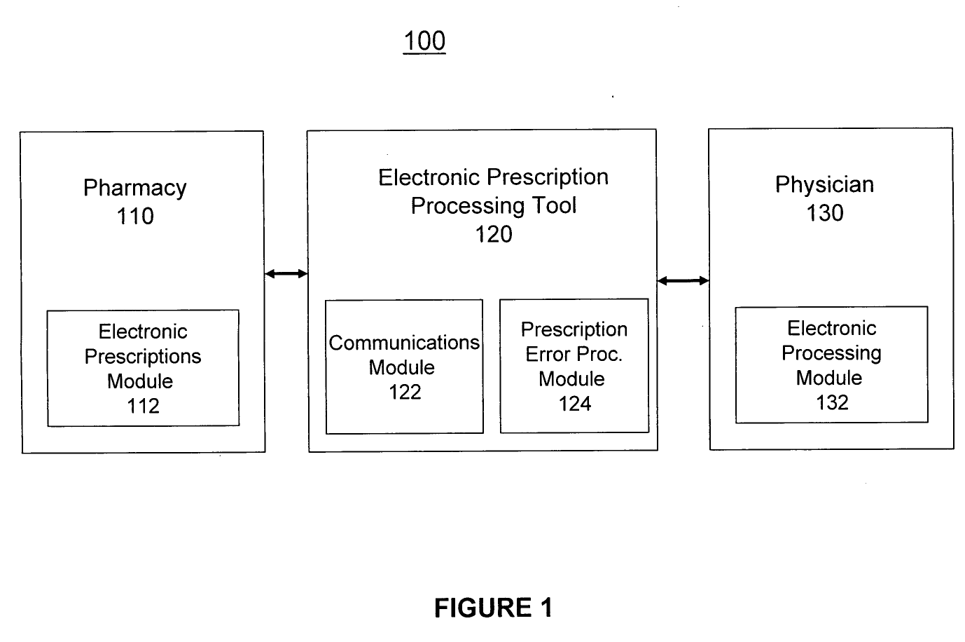

FIG. 1 depicts an overall block diagram 100 for implementing an electronic prescription system, in accordance with some embodiments. A pharmacy 110 is communicatively coupled to an electronic prescription tool 120. A physician's office 130 is also communicatively coupled to the electronic prescription tool 120.

The pharmacy 110 may be any retail pharmacy, mail order pharmacy, or patient care location. When a patient submits a prescription for filling, the pharmacy communicates with a prescription benefits manager associated with the patient's insurance company to determine, for example, whether the drug is covered and the cost, if any, to the patient. In accordance with an exemplary embodiment, the pharmacy 110 has associated therewith an electronic prescriptions module 112, which enables the pharmacy to efficiently communicate problems with the prescription back to the prescriber.

The prescriber may be, for example, the physician's office 130. The physician's office 130 may include an electronic processing module 132 for receiving notification of a prescription error and correcting the error.

The electronic prescription tool 120 may include a communications module 122 and a prescription error processing module 124. Other modules may also be included. The communications module 122 enables the pharmacy 110 and the physician's office 130 to exchange information regarding prescription errors. This module may be configured to receive reports of prescription errors from the pharmacy 110, communicate the error information to the physician's office 130, and provide a corrected prescription back to the pharmacy 110. The communication module 122 may also be configured to send electronic notifications to the physician's office 130 notifying the physician that a prescription error report has been generated. The physician may be notified of a pending transaction by pager, text message, email, phone call, fax, and/or other communication means. The physician's office 130 may select the type of notification to receive.

The prescription error processing module 124 may be configured to generate a prescription error report. Upon receipt of refusal report from the pharmacy 110, prescription error processing module may review the report and determines which drugs are identified. The error processing module 124 may be configured to check the drug for eligibility and determine whether any alternate drugs may be substituted for the prescribed drug. The patient's prescription history may also be checked to ensure there is no drug interaction or safety concerns with prescribing an alternate drug. These checks may be performed using, other commercially available or proprietary drug information processing databases.

The prescription error processing module 124 may be further configured to generate an error report to be transmitted to the physician's office 130. The error report may include, for example, the information about the prescription submitted by the pharmacy 120 as well any alternative drug and safety information which have been determined.

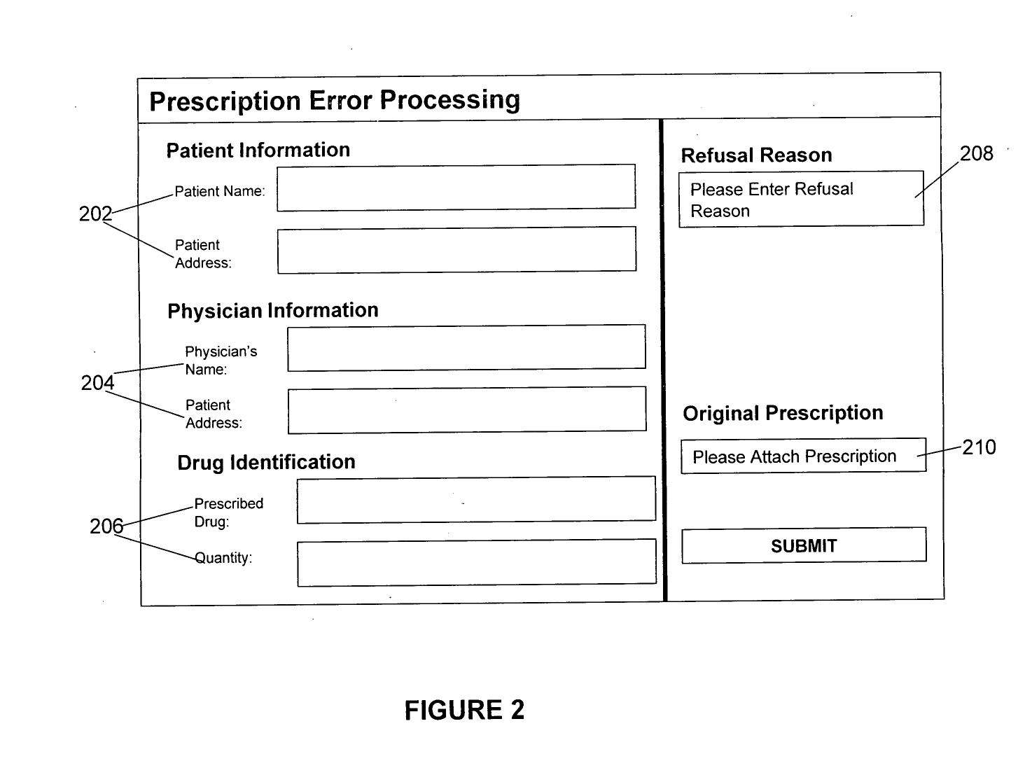

The pharmacy 110 enters information about a refused prescription into a web browser front end system generated by the electronic prescriptions module 112. FIG. 2 depicts an example of an user interface for entering refused prescription information. The interface includes a plurality of fields, including patient information fields 202, physician identifying fields 204, drug identification field 206, and refusal reason field 208. According to some embodiments, a prescription attachment field 210 may be included, allowing a copy of the original prescription to be attached.

The patient information fields 202 may include fields for entering the user's name, date of birth, address, and/or any other necessary identification information. The physician identifying fields 204 may include the physician's name, office address, identification number, phone number, fax number, and/or other information. The drug identification fields 206 may include fields for entering the name of the prescribed drug, the quantity prescribed, and/or other information.

A prescription may be refused by the prescription benefits manager for multiple reasons. For example, the drug may be off formulary, pre-authorization may be required, etc. The refusal reasons field 208 enables the pharmacy to enter the reason for refusal.

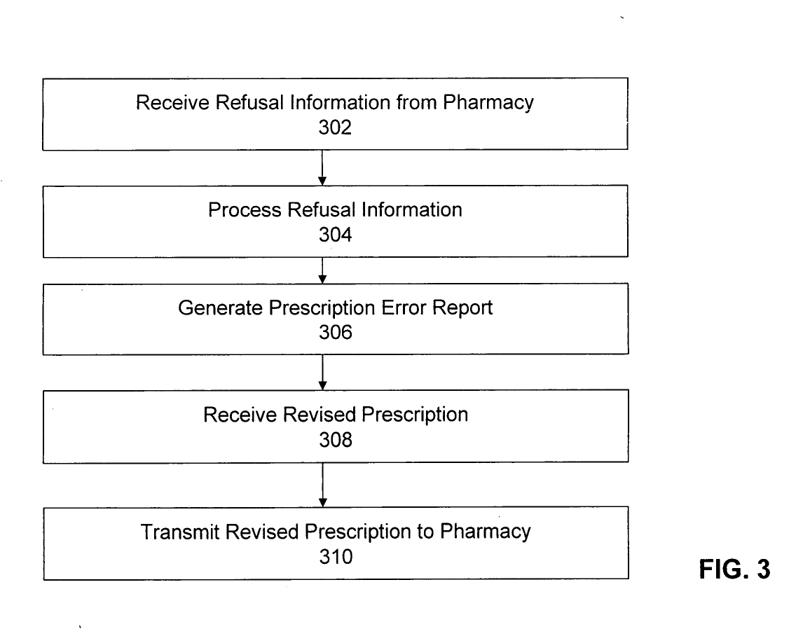

FIG. 3 depicts an overall method for processing prescriptions electronically. When a pharmacist receives a prescription from a patient, the pharmacist enters the prescription information into a benefits program to determine whether the prescribed drug is covered by the patient's insurance. If the prescribed drug is covered, the pharmacist fills the prescription in the normal manner.

As depicted at step 302, if the prescription is not covered, the pharmacist logs into the electronic prescription error program and enters information about the refused prescription. This information may include, for example, the patient's identifying information, the physician's identifying information, the drug's identifying information, and the reasons for refusal of the drug. An electronic copy of the original prescription may also be included.

As depicted at step 304, the information about the refused prescription is received by the electronic prescription tool. The electronic prescription tool processes the information by reviewing the information submitted by the pharmacist and determining whether any alternative drugs may be prescribed. As depicted at step 306, a report is generated and submitted to the physician's office. The report includes the information about the refused prescription as well as any suggested alternatives. The report may be transmitted electronically, for example as a PRISM™ electronic health record, or may be transmitted by fax or any other method of communication. A notification of the error report may also be submitted to the physician's office. PRISM™ provides mobile access to medical record information and ancillary resources, allowing physician's to access a patient's medical data at any location.

Upon receipt of the error report, the physician's office may execute an electronic prescription in PRISM™ or any other electronic prescription processing system to correct the errors, as depicted at step 308. Alternatively, the physician's office may submit a corrected prescription via fax, voice or any other communication method. The corrected prescription may be transmitted back to the electronic prescription tool, which in turn provides the corrected prescription to the pharmacist, as depicted at step 310.

The processes and methods described herein may be implemented in hard wired devices, firmware, or software running in a processor. Any of these processes may be contained on a computer readable medium. A computer readable medium may be any medium capable of carrying instructions to be performed by a microprocessor, including a CD disc, DVD disc, magnetic or optical disc, tape, silicon based removable or non-removable memory, packetized or non-packetized wireline or wireless transmission signals. Those of skill in the art will appreciate that a computer readable medium may carry instructions for a computer to perform the methods described herein.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims.

What is claimed is:

1. A computer-implemented system for electronic prescription processing comprising:
a communications module for receiving, from a pharmacy, a notification that a prescription cannot be filled; and
a prescription error processing module for generating an electronic report to the prescriber, the report informing the prescriber of one or more problems associated with the prescription and requesting correction.

2. The computer-implemented system of claim 1, wherein the notification includes patient identification information, prescriber identification information, drug identification information, and prescription error information.

3. The computer-implemented system of claim 2, wherein prescription error information includes one or more reasons why the prescription was refused payment by a prescription benefit manager.

4. The computer-implemented system of claim 1, wherein the prescription error processing module is further configured to determine whether any alternative drugs may be substituted for the originally prescribed drug.

5. The computer-implemented system of claim 4, wherein the prescription error processing module is further configured to retrieve the patient's prescription drug history and determine whether any adverse drug interactions would occur with the alternative drugs.

6. The computer-implemented system of claim 1, wherein the communication module is further configured to notify the prescriber that a report has been generated.

7. A computer-implemented method for electronic prescription processing comprising:
receiving, at a communications module, notification that a prescription has been refused by a prescription benefits manager;
determining whether any alternative drugs may be prescribed;
generating a report informing the prescriber that the prescription has been refused and requesting a new prescription; and
providing the new prescription to the pharmacy providing the notification.

8. The computer-implemented method of claim 7, wherein the notification includes patient identification information, prescriber identification information, drug identification information, and prescription error information.

9. The computer-implemented method of claim 7, wherein determining whether any alternative drugs may be prescribed further comprises:
retrieving the patient's prescription drug history and determining whether any adverse drug interactions would occur with the alternative drugs.
